(19) United States
(12) Patent Application Publication
(10) Pub. No.: US 2026/0167106 A1
(43) Pub. Date: Jun. 18, 2026

(54) INFORMATION NOTIFICATION DEVICE

(71) Applicant: Panasonic Automotive Systems Co., Ltd., Kanagawa (JP)

(72) Inventors: Tsuyoshi TANAKA, Kyoto (JP); Makoto ISHIBASHI, Kanagawa (JP)

(73) Assignee: Panasonic Automotive Systems Co., Ltd., Kanagawa (JP)

(21) Appl. No.: 19/361,499

(22) Filed: Oct. 17, 2025

(30) Foreign Application Priority Data
Dec. 13, 2024 (JP) 2024-218644

(51) Int. Cl. B60Q 9/00

(52) U.S. Cl. CPC B60Q 9/00

(57) ABSTRACT

An information notification device that notifies information to a driver via a steering wheel includes: a first vibrator disposed on a right side of the steering wheel when the steering wheel is in a neutral position; a second vibrator disposed on a left side of the steering wheel when the steering wheel is in the neutral position; and a controller that controls the first vibrator and the second vibrator, when the controller causes the first vibrator to vibrate, the controller causes the second vibrator to vibrate to suppress vibration on the left side of the steering wheel, and when the controller causes the second vibrator to vibrate, the controller causes the first vibrator to vibrate to suppress vibration on the right side of the steering wheel.

### CROSS REFERENCE TO RELATED APPLICATION

The present application is based on and claims priority of Japanese Patent Application No. 2024-218644 filed on December 13, 2024.

### Field

The present disclosure relates to an information notification device which can notify information, for example, by stimulating a driver in a vehicle.

### BACKGROUND

Conventionally, a warning device is known which detects a dangerous object approaching a vehicle driven by a driver, and notifies the driver of the detected dangerous object.

For example, Patent Literature (PTL) 1 discloses an information presentation device which presents information indicating a direction around a living body, and the information presentation device includes a control means which uses a tactile stimulation means serving as a start point side and a tactile stimulation means serving as an end point side when the direction is indicated to perform control such that the living body is stimulated on the start point side more emphatically than on the end point side, includes a plurality of physical vibrators as the tactile stimulation means, and causes a plurality of vibrators to vibrate on each of the start point side and the end point side when the direction is indicated.

### Citation List

### Patent Literature

PTL 1: Japanese Unexamined Patent Application Publication No. 2011-48566

### SUMMARY

However, the information presentation device according to PTL 1 above can be improved upon.

Hence, an object of the present disclosure is to provide an information notification device capable of improving upon the above related art.

An information notification device according to an aspect of the present disclosure is an information notification device that notifies information to a driver via a steering wheel, the information notification device includes: a first vibrator that is disposed on a right side of the steering wheel when the steering wheel is in a neutral position; a second vibrator that is disposed on a left side of the steering wheel when the steering wheel is in the neutral position; and a controller that controls the first vibrator and the second vibrator, when the controller causes the first vibrator to vibrate, the controller causes the second vibrator to vibrate to suppress vibration on the left side of the steering wheel, and when the controller causes the second vibrator to vibrate, the controller causes the first vibrator to vibrate to suppress vibration on the right side of the steering wheel.

The information notification device according to the aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view showing an example of a vehicle including a steering wheel in which an information notification device according to an embodiment is disposed.

FIG. 2 is a block diagram showing the information notification device according to the embodiment.

FIG. 3 is a diagram showing waveforms when the steering wheel vibrates.

FIG. 4 is a schematic view showing an example of a vehicle including a steering wheel in which the information notification device further including a gripping position detector is disposed.

FIG. 5 is a block diagram showing the information notification device further including the gripping position detector.

FIG. 6 is a flowchart showing the information notification device in operation example 1.

FIG. 7 is a flowchart showing the information notification device in operation example 2.

### DESCRIPTION OF EMBODIMENT

An embodiment will be specifically described below with reference to drawings.

The embodiment described below indicates a general or specific example. Numerical values, shapes, materials, constituent elements, the arrangement and connection of the constituent elements, steps, the order of the steps, and the like shown in the following embodiment are examples, and are not intended to limit the present disclosure. Among the constituent elements in the following embodiment, constituent elements which are not recited in the independent claim are described as optional constituent elements.

The drawings are schematic views, and are not exactly shown. In the drawings, substantially the same configurations are identified with the same reference signs, and repeated description may be omitted or simplified.

In the following embodiment, expressions such as T-shaped and a circumferential direction are used. For example, T-shaped, and a circumferential direction mean not only completely T-shaped, and a completely circumferential direction but also substantially T-shaped, and a substantially circumferential direction. In other words, substantially T-shaped, and a substantially circumferential direction also mean that a several percent error is included. In a range where effects in the present disclosure can be achieved, T-shaped, and a circumferential direction are provided. The same is true for other expressions using “shaped”, and “direction”.

### EMBODIMENT

### Configurations and Functions

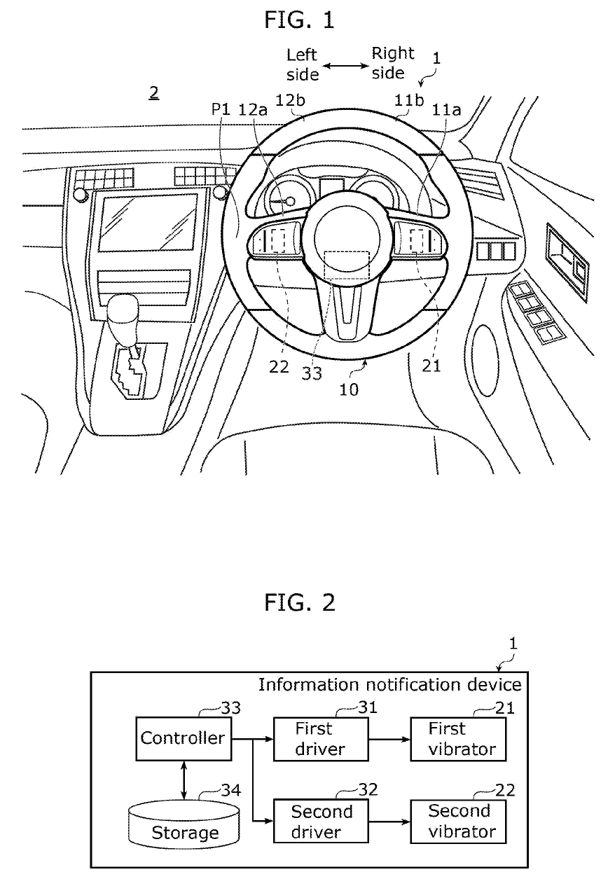

The configurations of steering wheel 10 in vehicle 2 and information notification device 1 incorporated in steering wheel 10 will first be described with reference to FIGS. 1 to 5.

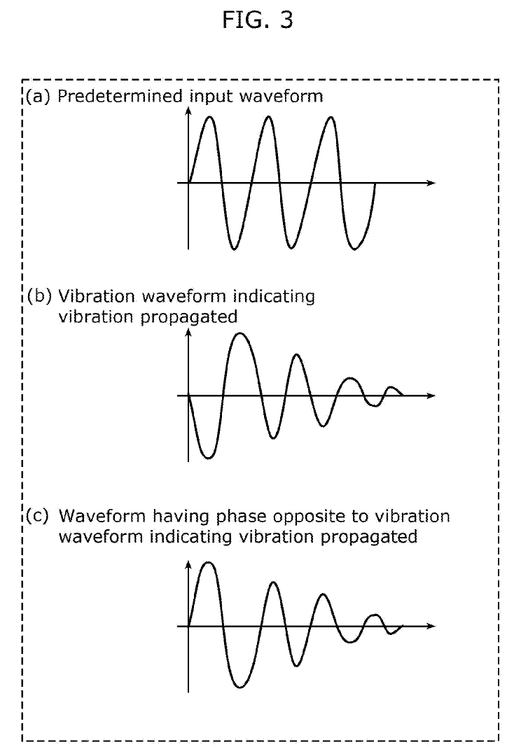

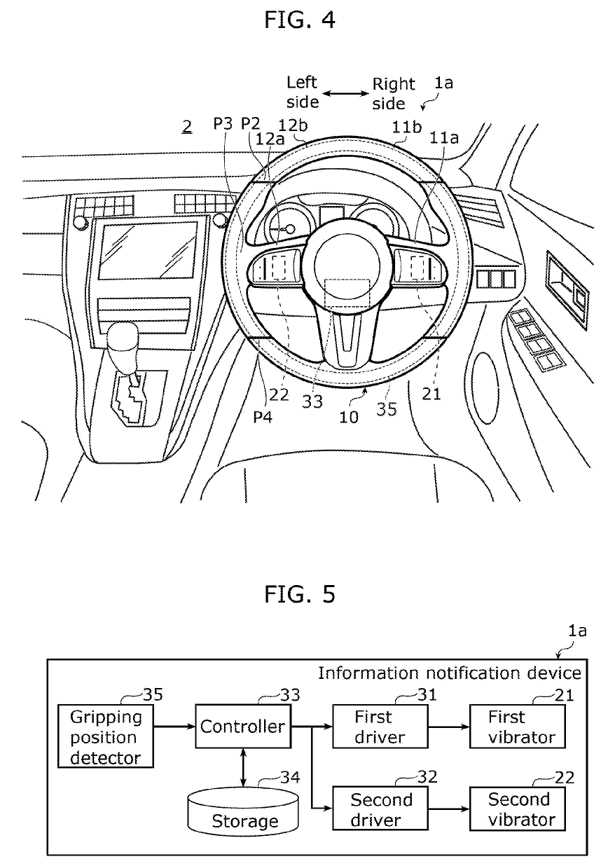

FIG. 1 is a schematic view showing an example of vehicle 2 including steering wheel 10 in which information notification device 1 according to the embodiment is disposed. FIG. 2 is a block diagram showing information notification device 1 according to the embodiment. FIG. 3 is a diagram showing waveforms when steering wheel 10 vibrates. Part (a) in FIG. 3 is a predetermined input waveform for causing first vibrator 21 or second vibrator 22 to vibrate. In part (a) in FIG. 3, the input waveform for three cycles is illustrated. Part (b) in FIG. 3 shows, when a vibrator on one side of steering wheel 10 (first vibrator 21 on the right side or second vibrator 22 on the left side) is caused to vibrate with the predetermined input waveform shown in part (a) in FIG. 3, a vibration waveform indicating vibration propagated to the other side (the left side or the right side) of steering wheel 10. Part (c) in FIG. 3 shows a waveform (a first waveform or a second waveform) having a phase opposite to the vibration waveform indicating the vibration propagated to the other side (the left side or the right side) of steering wheel 10. FIG. 4 is a schematic view showing an example of vehicle 2 including steering wheel 10 in which information notification device 1 further including gripping position detector 35 is disposed. FIG. 5 is a block diagram showing information notification device 1 which further includes gripping position detector 35.

As shown in FIG. 1, steering wheel 10 can provide a steering angle to the steering wheels of vehicle 2. Steering wheel 10 includes a rim, a spoke, and a hub.

An exterior cover is wrapped around the exterior of the rim and the spoke. The rim is a grip part which is gripped by hands of a driver. When steering wheel 10 is in a neutral position, the rim includes right-side rim 11b located on the right side and left-side rim 12b located on the left side. Right-side rim 11b and left-side rim 12b are integrally formed, and are ring-shaped. Although the rim shown in FIG. 1 is ring-shaped, the shape of the rim is not limited to the ring shape. The rim may be in an irregular shape such as a yoke shape, a D-shape, or an oval shape. The right side is a right side as viewed along the front of vehicle 2 when steering wheel 10 is in the neutral position. The left side is a left side as viewed along the front of vehicle 2 when steering wheel 10 is in the neutral position.

The rim includes a core and a foam which covers the core. The foam is provided on the core along the shape of the core. The foam is formed of a resin material of a urethane resin such as polyurethane.

The spoke is a support member for connecting the rim and the hub. The spoke also includes a core and a foam which covers the core. The spoke is disposed on the inner circumferential surface of the rim. When steering wheel 10 is in the neutral position, the spoke includes right-side spoke 11a located on a right side relative to the hub, left-side spoke 12a located on a left side relative to the hub, and a lower-side spoke located on a lower side relative to the hub. Right-side spoke 11a, left-side spoke 12a, and the lower-side spoke are formed integrally with the rim, and are T-shaped.

The hub is a member for transmitting a rotational force corresponding to an operation performed on the rim to a steering shaft, and is located in a center part of steering wheel 10.

Information notification device 1 can notify information to the driver via steering wheel 10. Specifically, information notification device 1 causes steering wheel 10 to vibrate to be able to notify information to the driver by the tactile sense of the driver (vibration sensation). Examples of information to be notified to the driver includes information indicating that vehicle 2 is traveling toward a right or left lane, information indicating that vehicle 2 driven by the driver is turning right or left according to the travel route of a navigation system, information indicating the presence of a following vehicle approaching from the right rear or left rear of vehicle 2 when the vehicle is turning right or left, and the like.

Specifically, as shown in FIGS. 1 and 2, information notification device 1 includes first vibrator 21, second vibrator 22, first driver 31, second driver 32, controller 33, and storage 34.

When steering wheel 10 is in the neutral position, first vibrator 21 is disposed on the right side of steering wheel 10. First vibrator 21 is disposed at right-side spoke 11a or right-side rim 11b of steering wheel 10. In the present embodiment, first vibrator 21 is disposed at right-side spoke 11a together with a steering switch. In the present embodiment, “on the right side of steering wheel 10 when steering wheel 10 is in the neutral position” may be simply referred to as “on the right side of steering wheel 10”.

First vibrator 21 is, for example, a vibration motor. First vibrator 21 is driven by first driver 31 which is controlled by controller 33, and thus first vibrator 21 can vibrate the right side of steering wheel 10 such that when the driver grips steering wheel 10, the driver can recognize the vibration.

When steering wheel 10 is in the neutral position, second vibrator 22 is disposed on the left side of steering wheel 10. Second vibrator 22 is disposed at left-side spoke 12a or left-side rim 12b of steering wheel 10. In the present embodiment, second vibrator 22 is disposed at left-side spoke 12a together with a steering switch. In the present embodiment, “on the left side of steering wheel 10 when steering wheel 10 is in the neutral position” may be simply referred to as “on the left side of steering wheel 10”.

Second vibrator 22 is, for example, a vibration motor. Second vibrator 22 is driven by second driver 32 which is controlled by controller 33, and thus second vibrator 22 can vibrate the left side of steering wheel 10 such that when the driver grips steering wheel 10, the driver can recognize the vibration.

First driver 31 is a function generator for causing first vibrator 21 to vibrate. First driver 31 is controlled by controller 33 to output a predetermined input waveform to first vibrator 21, and thereby can cause first vibrator 21 to vibrate with the predetermined input waveform.

Second driver 32 is a function generator for causing second vibrator 22 to vibrate. Second driver 32 is controlled by controller 33 to output a predetermined input waveform to second vibrator 22, and thereby can cause second vibrator 22 to vibrate with the predetermined input waveform.

Although the predetermined input waveform is, for example, a sinusoidal signal waveform shown in part (a) in FIG. 3, the predetermined input waveform is not limited to a sinusoidal signal waveform, and may be a signal waveform which is arbitrarily set.

Each of the signal waveform output by first driver 31 to first vibrator 21 and the signal waveform output by second driver 32 to second vibrator 22 may be amplified via an amplifier.

Storage 34 is a memory which stores the predetermined input waveforms with which controller 33 causes first vibrator 21 and second vibrator 22 to vibrate.

Controller 33 can individually control first vibrator 21 and second vibrator 22. Specifically, controller 33 controls first driver 31 to be able to control the vibration of first vibrator 21, and controls second driver 32 to be able to control the vibration of second vibrator 22.

The functions of information notification device 1 incorporated in steering wheel 10 of vehicle 2 will then be described.

For example, when as shown in part (a) in FIG. 3, a vibrator disposed on one side of steering wheel 10 (for example, first vibrator 21 on the right side) vibrates with the predetermined input waveform, as shown in FIG. 1 and part (b) in FIG. 3, vibration on the other side (left side) of steering wheel 10 is attenuated, and thus at arbitrary point P1 on the other side of steering wheel 10, the vibration waveform is propagated while being attenuated. Hence, as shown in part (c) in FIG. 3, a vibrator disposed on the other side of steering wheel 10 is caused to vibrate with a waveform having a phase opposite to the vibration waveform indicating the vibration propagated to the other side of steering wheel 10, and thus it is possible to suppress the vibration at arbitrary point P1 on the other side of steering wheel 10. In particular, if arbitrary point P1 is set to a gripping position where the driver frequently grips steering wheel 10, when the driver grips steering wheel 10, it is possible to cause the driver to more easily recognize the vibration on the one side of steering wheel 10 and to cause the driver to be unlikely to recognize the vibration on the other side of steering wheel 10.

Specifically, when as shown in FIG. 2 and part (a) in FIG. 3, controller 33 controls first driver 31 to cause first vibrator 21 to vibrate with the predetermined input waveform, controller 33 can cause second vibrator 22 to vibrate to suppress the vibration on the left side of steering wheel 10.

For example, when as shown in part (a) in FIG. 3, first vibrator 21 vibrates with the predetermined input waveform, as shown in part (b) in FIG. 3, the vibration of first vibrator 21 is propagated to second vibrator 22 while being attenuated via the rim and the spoke in steering wheel 10.

In the present embodiment, controller 33 controls second driver 32 to cause second vibrator 22 to vibrate such that the vibration on the left side of steering wheel 10 is suppressed. Specifically, as shown in FIG. 2 and part (c) in FIG. 3, when controller 33 causes first vibrator 21 to vibrate, controller 33 can cause second vibrator 22 to vibrate with a first waveform having a phase opposite to the vibration waveform indicating the vibration propagated to the left side of steering wheel 10. In this way, controller 33 causes second vibrator 22 to vibrate to cancel out the vibration propagated to the left side of steering wheel 10, and thereby can suppress the vibration on the left side of steering wheel 10. Consequently, when the right hand of the driver grips the right side of steering wheel 10, and the left hand of the driver grips the left side of steering wheel 10, since the right side of steering wheel 10 vibrates, and the vibration on the left side of steering wheel 10 is suppressed, it is possible to cause the driver to easily recognize the vibration on the right side of steering wheel 10.

When controller 33 controls second driver 32 to cause second vibrator 22 to vibrate with the predetermined input waveform, controller 33 can cause first vibrator 21 to vibrate to suppress the vibration on the right side of steering wheel 10.

For example, when as shown in part (a) in FIG. 3, second vibrator 22 vibrates with the predetermined input waveform, as shown in part (b) in FIG. 3, the vibration of second vibrator 22 is propagated to first vibrator 21 while being attenuated via the rim and the spoke in steering wheel 10.

In the present embodiment, controller 33 controls first driver 31 to cause first vibrator 21 to vibrate such that the vibration on the right side of steering wheel 10 is suppressed. Specifically, as shown in FIG. 2 and part (c) in FIG. 3, when controller 33 causes second vibrator 22 to vibrate, controller 33 can cause first vibrator 21 to vibrate with a second waveform having a phase opposite to the vibration waveform indicating the vibration propagated to the right side of steering wheel 10. In this way, controller 33 causes first vibrator 21 to vibrate to cancel out the vibration propagated to the right side of steering wheel 10, and thereby can suppress the vibration on the right side of steering wheel 10. Consequently, when the left hand of the driver grips the left side of steering wheel 10, and the right hand of the driver grips the right side of steering wheel 10, since the left side of steering wheel 10 vibrates, and the vibration on the right side of steering wheel 10 is suppressed, it is possible to cause the driver to easily recognize the vibration on the left side of steering wheel 10.

In the present embodiment, the first waveform and the second waveform are stored in storage 34 beforehand. This can be realized by the following operation: when first vibrator 21 disposed on the right side of steering wheel 10 is caused to vibrate, the first waveform which has the phase opposite to the waveform indicating the vibration propagated to second vibrator 22 disposed on the left side of steering wheel 10 to cancel out vibration in the gripping position where the driver frequently grips steering wheel 10 is measured beforehand, and the first waveform is stored in storage 34. This can also be realized by the following operation: when second vibrator 22 disposed on the left side of steering wheel 10 is caused to vibrate, the second waveform which has the phase opposite to the waveform indicating the vibration propagated to first vibrator 21 disposed on the right side of steering wheel 10 to cancel out vibration in the gripping position where the driver frequently grips steering wheel 10 is measured beforehand, and the second waveform is stored in storage 34.

Hence, controller 33 reads the first waveform stored in storage 34 while causing first vibrator 21 to vibrate with the predetermined input waveform, and thereby can cause second vibrator 22 to vibrate with the first waveform. Controller 33 also reads the second waveform stored in storage 34 while causing second vibrator 22 to vibrate with the predetermined input waveform, and thereby can cause first vibrator 21 to vibrate with the second waveform.

Storage 34 also stores the predetermined input waveforms beforehand. Storage 34 can be realized by a semiconductor memory or the like.

Since as described above, the first waveform and the second waveform are stored in storage 34 beforehand, when controller 33 causes first vibrator 21 to vibrate with the predetermined input waveform, controller 33 can perform control to cause second vibrator 22 to vibrate with the first waveform, and when controller 33 causes second vibrator 22 to vibrate with the predetermined input waveform, controller 33 can perform control to cause first vibrator 21 to vibrate with the second waveform.

In the present embodiment, the phase opposite to the waveform of vibration means not only a case where the phase is completely opposite to the waveform of vibration but also, for example, a case where only a part of the amplitude and the phase of the waveform of vibration are different. The opposite phase is not limited as long as the effects of the present disclosure can be achieved.

As shown in FIGS. 4 and 5, information notification device 1a in the present embodiment may further include gripping position detector 35.

Gripping position detector 35 can detect the position of the hand of the driver which grips steering wheel 10. Gripping position detector 35 is a sensor electrode which is provided inside the exterior cover wrapped around the rim to detect that the hand of the driver makes contact with the exterior cover. Gripping position detector 35 is disposed along the circumferential direction of the rim. Gripping position detector 35 may be divided into a plurality of parts which are disposed over the entire circumference of the rim. For example, one gripping position detector 35 may be disposed on the right side of the rim, and other gripping position detector 35 may be disposed on the left side of the rim.

When gripping position detector 35 detects that the hand of the driver grips steering wheel 10, gripping position detector 35 inputs a detection signal to controller 33.

Controller 33 has the function of detecting, based on the detection signal output from gripping position detector 35, that the hand of the driver grips steering wheel 10. Controller 33 can detect whether the hand of the driver is in contact with steering wheel 10 by a change in capacitance between the hand of the driver and gripping position detector 35. Controller 33 also uses a plurality of gripping position detectors 35 to be able to detect contact positions of the hands of the driver.

When gripping position detector 35 is used, a table of a plurality of first waveforms which correspond one-to-one to a plurality of gripping positions on the left side of steering wheel 10 and a table of a plurality of second waveforms which correspond one-to-one to a plurality of gripping positions on the right side of steering wheel 10 may be stored in storage 34 beforehand. Controller 33 can use the tables to cause second vibrator 22 or first vibrator 21 to vibrate with the first waveform or the second waveform corresponding to the gripping position.

Specifically, when gripping position detector 35 can detect, as a plurality of gripping positions on the left side of steering wheel 10, for example, three ranges of an upper side range on the left side of steering wheel 10, a center side range on the left side, and a lower side range on the left side, a table of three first waveforms which correspond one-to-one to the three gripping positions may be stored in storage 34.

The three first waveforms are, for example, an upper left first waveform having a phase opposite to a vibration waveform indicating vibration propagated to the upper side range on the left side of steering wheel 10, a left center first waveform having a phase opposite to a vibration waveform indicating vibration propagated to the center side range on the left side of steering wheel 10, and a lower left first waveform having a phase opposite to a vibration waveform indicating vibration propagated to the lower side range on the left side of steering wheel 10 when first vibrator 21 is caused to vibrate.

When controller 33 causes first vibrator 21 to vibrate, controller 33 can cause second vibrator 22 to vibrate with, among the three first waveforms, a first waveform having a phase opposite to a vibration waveform indicating vibration propagated to the left side of steering wheel 10 corresponding to the gripping position detected by gripping position detector 35 and indicated by the detection signal.

Specifically, when controller 33 causes first vibrator 21 to vibrate, if the gripping position detected by gripping position detector 35 indicates point P2 (see FIG. 4) included in the upper side range on the left side of steering wheel 10, controller 33 can cause second vibrator 22 to vibrate with the upper left first waveform. Likewise, when controller 33 causes first vibrator 21 to vibrate, if the gripping position detected by gripping position detector 35 indicates point P3 included in the center side range on the left side of steering wheel 10, controller 33 can cause second vibrator 22 to vibrate with the left center first waveform. Likewise, when controller 33 causes first vibrator 21 to vibrate, if the gripping position detected by gripping position detector 35 indicates point P4 included in the lower side range on the left side of steering wheel 10, controller 33 can cause second vibrator 22 to vibrate with the lower left first waveform.

Regarding a plurality of gripping positions on the right side of steering wheel 10, likewise, when gripping position detectors 35 can detect, for example, three ranges of an upper side range on the right side of steering wheel 10, a center side range on the right side, and a lower side range on the right side, a table of three second waveforms which correspond one-to-one to the three gripping positions may be stored in storage 34. The three second waveforms are, for example, an upper right second waveform having a phase opposite to a vibration waveform indicating vibration propagated to the upper side range on the right side of steering wheel 10, a right center second waveform having a phase opposite to a vibration waveform indicating vibration propagated to the center side range on the right side of steering wheel 10, and a lower right second waveform having a phase opposite to a vibration waveform indicating vibration propagated to the lower side range on the right side of steering wheel 10 when second vibrator 22 is caused to vibrate.

As described above, when controller 33 causes first vibrator 21 to vibrate, controller 33 can cause second vibrator 22 to vibrate with the first waveform having a phase opposite to a vibration waveform indicating vibration propagated to the left side of steering wheel 10 according to the gripping position detected by gripping position detector 35 and indicated by the detection signal. In this way, controller 33 causes second vibrator 22 to vibrate to cancel out the vibration propagated to the left side of steering wheel 10 according to the gripping position, and thus it is possible to suppress the vibration on the left side of steering wheel 10. Consequently, when the right hand of the driver grips the right side of steering wheel 10, and the left hand of the driver grips the left side of steering wheel 10, since vibration in a part where the left hand grips steering wheel 10 is suppressed, it is possible to cause the driver to be unlikely to recognize the vibration on the left side of steering wheel 10, and to cause the driver to easily recognize the vibration on the right side of steering wheel 10.

When controller 33 causes second vibrator 22 to vibrate, controller 33 can cause first vibrator 21 to vibrate with the second waveform having a phase opposite to a vibration waveform indicating vibration propagated to the right side of steering wheel 10 according to the gripping position detected by gripping position detector 35 and indicated by the detection signal. In this way, controller 33 causes first vibrator 21 to vibrate to cancel out the vibration propagated to the right side of steering wheel 10 according to the gripping position, and thus it is possible to suppress the vibration on the right side of steering wheel 10. Consequently, when the left hand of the driver grips the left side of steering wheel 10, and the right hand of the driver grips the right side of steering wheel 10, since vibration in a part where the right hand grips steering wheel 10 is suppressed, it is possible to cause the driver to be unlikely to recognize the vibration on the right side of steering wheel 10, and to cause the driver to easily recognize the vibration on the left side of steering wheel 10.

In this case, a table of a plurality of first waveforms which correspond one-to-one to a plurality of gripping positions on the left side of steering wheel 10 and a table of a plurality of second waveforms which correspond one-to-one to a plurality of gripping positions on the right side of steering wheel 10 may be stored in storage 34 beforehand. Controller 33 can use the tables to cause second vibrator 22 or first vibrator 21 to vibrate with the first waveform or the second waveform corresponding to the gripping position.

### Operation

### Operation Example 1

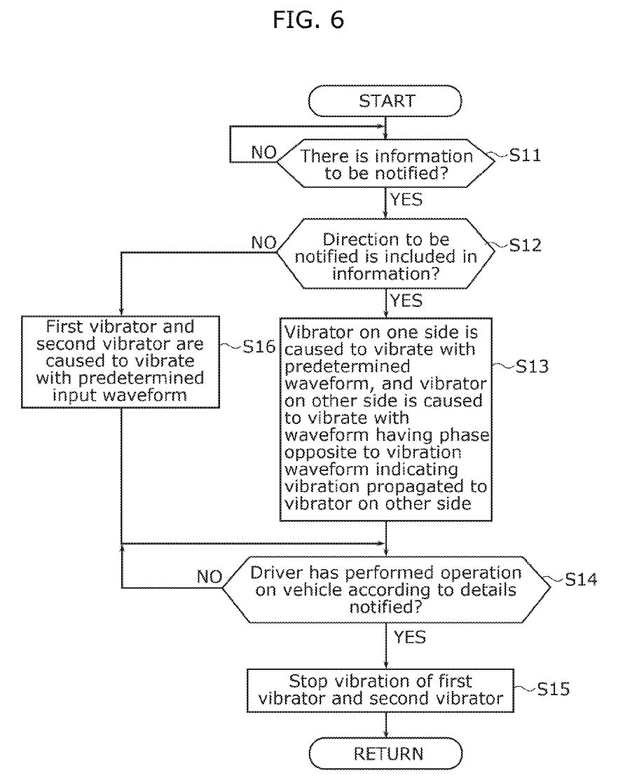

Operation example 1 of information notification device 1 will then be described with reference to FIG. 6.

FIG. 6 is a flowchart showing information notification device 1 in operation example 1.

Controller 33 of information notification device 1 first determines whether there is information to be notified to the driver via steering wheel 10 (S11).

For example, when a lane departure suppression system incorporated in vehicle 2 detects that vehicle 2 is traveling toward a right or left lane, the lane departure suppression system notifies information notification device 1 that vehicle 2 is traveling toward the right or left lane as information to be notified. In another example, when vehicle 2 turns right or left according to a travel route, a navigation system incorporated in vehicle 2 notifies information notification device 1 that vehicle 2 will turn right or left as the information to be notified. In still another example, when vehicle 2 is changing lanes in a rightward direction or a leftward direction, if a following vehicle is approaching from the right rear or left rear of vehicle 2, a rear side warning support system incorporated in vehicle 2 notifies information notification device 1 of the presence of the following vehicle approaching from the right rear or left rear of vehicle 2 as the information to be notified.

When controller 33 determines that there is no information to be notified to the driver via steering wheel 10 (no in S11), the operation processing returns to step S11, and the processing in step S11 is performed.

On the other hand, when controller 33 determines that there is information to be notified to the driver via steering wheel 10 (yes in S11), controller 33 determines whether the information to be notified to the driver includes a direction to be notified (S12).

The direction to be notified is the rightward direction or the leftward direction of vehicle 2. Examples of a case where the direction to be notified is the rightward direction of vehicle 2 includes a case where vehicle 2 is traveling toward the right lane, a case where vehicle 2 turns right according to the travel route, and a case where when vehicle 2 changes lanes to the right side, there is a following vehicle which approaches from the right rear of vehicle 2. Examples of a case where the direction to be notified is the leftward direction of vehicle 2 includes a case where vehicle 2 is traveling toward the left lane, a case where vehicle 2 turns left according to the travel route, and a case where when vehicle 2 changes lanes to the left side, there is a following vehicle which approaches from the left rear of vehicle 2. As described above, the notification means for the driver is a means for vibrating the right side or the left side of steering wheel 10 to notify the driver whether attention should be directed to the rightward direction or the leftward direction.

When controller 33 determines that the information to be notified to the driver includes the direction to be notified (yes in S12), controller 33 controls first driver 31 and second driver 32 according to the direction to be notified to cause first vibrator 21 and second vibrator 22 to vibrate. In other words, controller 33 causes the vibrator on one side to vibrate with the predetermined input waveform, and causes the vibrator on the other side to vibrate with a waveform having a phase opposite to a vibration waveform indicating vibration propagated to the vibrator on the other side (S13).

For example, as in a case where a notification is provided that vehicle 2 is traveling toward the right lane, a case where since vehicle 2 is traveling toward the left lane, a notification is provided that steering wheel 10 should be rotated to the right side, a case where the travel route notifies the driver that vehicle 2 will turn right, a case where when vehicle 2 changes lanes to the right side, a notification is provided that a following vehicle approaches from the right rear, or the like, there is a case where the direction to be notified to the driver is the right side. Here, when controller 33 controls first driver 31 and second driver 32 to cause first vibrator 21 to vibrate with the predetermined input waveform, controller 33 causes second vibrator 22 to vibrate with the first waveform having a phase opposite to a vibration waveform indicating vibration propagated to the left side of steering wheel 10. In this way, when both hands of the driver grip steering wheel 10, the right side of steering wheel 10 vibrates, vibration on the left side of steering wheel 10 is suppressed, and thus it is possible to cause the driver to easily recognize that the direction notified via steering wheel 10 is the rightward direction of vehicle 2.

For example, as in a case where a notification is provided that vehicle 2 is traveling toward the left lane, a case where since vehicle 2 is traveling toward the right lane, a notification is provided that steering wheel 10 should be rotated to the left side, a case where the travel route indicates that vehicle 2 will turn left, a case where when vehicle 2 changes lanes to the left side, a notification is provided that a following vehicle approaches from the left rear, or the like, there is a case where the direction to be notified to the driver is the left side. Here, when controller 33 controls first driver 31 and second driver 32 to cause second vibrator 22 to vibrate with the predetermined input waveform, controller 33 causes first vibrator 21 to vibrate with the second waveform having a phase opposite to a vibration waveform indicating vibration propagated to the right side of steering wheel 10. In this way, when both hands of the driver grip steering wheel 10, the left side of steering wheel 10 vibrates, vibration on the right side of steering wheel 10 is suppressed, and thus it is possible to cause the driver to easily recognize that the direction notified via steering wheel 10 is the leftward direction of vehicle 2.

Then, controller 33 determines, after the direction to be notified is presented to the driver, whether the driver has performed an operation on vehicle 2 according to details notified to the driver (S14).

In step S14, controller 33 may determine, after the direction to be notified is presented to the driver, whether a predetermined period has elapsed. When the predetermined period has elapsed, controller 33 may cause the operation processing to proceed to step S15. When the predetermined period has not elapsed, controller 33 may return the operation processing to step S14.

When controller 33 determines, after the direction to be notified is presented to the driver, that the driver has not performed the operation on vehicle 2 according to the details notified to the driver (no in S14), the operation processing is returned to step S14, and the processing in step S14 is performed.

On the other hand, when controller 33 determines, after the direction to be notified is presented to the driver, that the driver has performed the operation on vehicle 2 according to the details notified to the driver (yes in S14), controller 33 stops the vibration of first vibrator 21 and second vibrator 22 (S15).

Then, controller 33 returns the operation processing to step S11, and repeats the flowchart shown in FIG. 6.

Here, description of the processing in step S12 will be given again.

On the other hand, when controller 33 determines that the direction to be notified is not included in the information to be notified to the driver (no in S12), controller 33 controls first driver 31 and second driver 32 to cause first vibrator 21 and second vibrator 22 to vibrate with the predetermined input waveform (S16).

For example, when vehicle 2 is parked in a parking lot while being backed up, if vehicle 2 approaches within a predetermined distance from an obstacle, entire steering wheel 10 can be vibrated. In this way, when both hands of the driver grip steering wheel 10, the driver can recognize, by the vibration of steering wheel 10, that the direction notified via steering wheel 10 is the forward direction or the backward direction of vehicle 2. In this way, information notification device 1 can notify the information to the driver. Then, controller 33 performs the processing in step S14, returns the operation processing to step S11 after step S15, and repeats the flowchart shown in FIG. 6.

### Operation Example 2

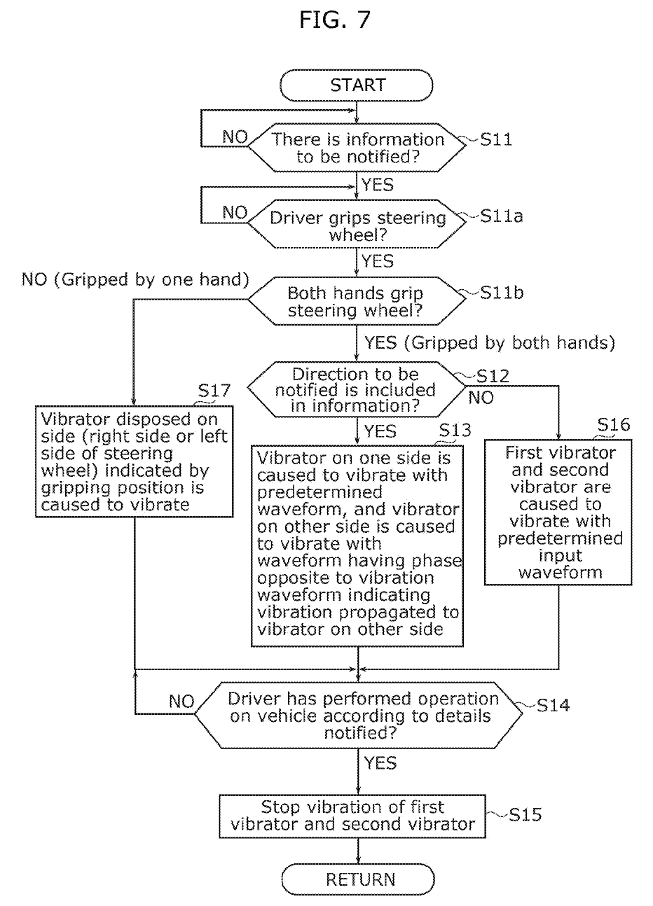

Operation example 2 of information notification device 1a which incorporates gripping position detector 35 will then be described with reference to FIG. 7.

FIG. 7 is a flowchart showing information notification device 1a in operation example 2. In FIG. 7, information notification device 1a of steering wheel 10 which incorporates gripping position detector 35 will be described.

In the following description, the same processing steps as in FIG. 6 are identified with the same reference signs, and the description thereof is omitted as necessary.

After step S11, controller 33 first determines whether the driver grips steering wheel 10 (S11a).

When controller 33 determines that the driver does not grip steering wheel 10 (no in S11a), the operation processing is returned to step S11a, and the processing in step S11a is performed.

On the other hand, when controller 33 determines that the driver grips steering wheel 10 (yes in S11a), controller 33 determines, from gripping positions of steering wheel 10 indicated by detection signals output from gripping position detector 35, whether both hands grip steering wheel 10 (S11b).

When controller 33 determines, from the gripping positions of steering wheel 10 indicated by the detection signals, that both hands grip steering wheel 10 (yes in S11b (gripped by both hands)), controller 33 determines whether the direction to be notified is included in the information to be notified to the driver (S12).

Then, when the determination in step S12 is yes, in information notification device 1a, after steps S13 to S15, controller 33 returns the operation processing to step S11, and repeats the flowchart shown in FIG. 7. In step S13, as described above, when gripping position detector 35 can detect a plurality of gripping positions of steering wheel 10, first vibrator 21 or second vibrator 22 can be caused to vibrate with a waveform (the first waveform or the second waveform) having a phase opposite to a vibration waveform indicating vibration propagated to the other side (the left side or the right side) of steering wheel 10 corresponding to the gripping positions detected by gripping position detector 35 and indicated by the detection signals.

On the other hand, when the determination in step S12 is no, after steps S16, S14, and S15, controller 33 returns the operation processing to step S11, and repeats the flowchart shown in FIG. 7.

Here, description of the processing in step S11b will be given again.

When controller 33 determines, from the gripping positions of steering wheel 10 indicated by the detection signals, that a hand grips steering wheel 10 (no in S11b (gripped by one hand)), controller 33 causes a vibrator (first vibrator 21 or second vibrator 22) disposed on the side (the right side or the left side of steering wheel 10) indicated by the gripping position to vibrate (S17).

For example, when the gripping position indicates only the right side of steering wheel 10, controller 33 controls first driver 31 to be able to cause only first vibrator 21 to vibrate with the predetermined input waveform. When the gripping position indicates only the left side of steering wheel 10, controller 33 controls second driver 32 to be able to cause only second vibrator 22 to vibrate with the predetermined input waveform.

Then, after steps S14 and S15, controller 33 returns the operation processing to step S11, and repeats the flowchart shown in FIG. 7.

### Operational Effects

Operational effects of information notification devices 1 and 1a according to the present embodiment will then be described.

However, in the technique disclosed in PTL 1, in a case where vibrators are disposed on the left and right sides of a steering wheel, when one of the vibrators is caused to vibrate, the entire steering wheel vibrates. Hence, even when information to be notified to a driver includes a direction indicating one of the right side and the left side of a vehicle, it is difficult for the driver to recognize the intention of the vibration, with the result that it is disadvantageously difficult to accurately convey the intention of the vibration to the driver. Hence, information notification device 1 or 1a in technique 1 according to the present embodiment is information notification device 1 or 1a that notifies information to a driver via steering wheel 10, information notification device 1 or 1a includes: first vibrator 21 that is disposed on a right side of steering wheel 10 when steering wheel 10 is in a neutral position; second vibrator 22 that is disposed on a left side of steering wheel 10 when steering wheel 10 is in the neutral position; and controller 33 that controls first vibrator 21 and second vibrator 22, when controller 33 causes first vibrator 21 to vibrate, controller 33 causes second vibrator 22 to vibrate to suppress vibration on the left side of steering wheel 10, and when controller 33 causes second vibrator 22 to vibrate, controller 33 causes first vibrator 21 to vibrate to suppress vibration on the right side of steering wheel 10.

In this way, when both hands of the driver grip steering wheel 10, if information to be notified to the driver is the rightward direction of vehicle 2, the right side of steering wheel 10 can be emphasized and vibrated, and if the information to be notified to the driver is the leftward direction of vehicle 2, the left side of steering wheel 10 can be emphasized and vibrated. Hence, the driver easily recognizes, by tactile sense, whether the notified information is the rightward direction or the leftward direction of vehicle 2.

Therefore, in information notification device 1 or 1a, the information to be notified to the driver can be clarified and easily recognized.

Information notification device 1 in technique 2 according to the present embodiment is information notification device 1 in technique 1. In this case, when controller 33 causes first vibrator 21 to vibrate, controller 33 causes second vibrator 22 to vibrate with a first waveform having a phase opposite to a phase of a vibration waveform indicating vibration propagated to the left side of steering wheel 10, and when controller 33 causes second vibrator 22 to vibrate, controller 33 causes first vibrator 21 to vibrate with a second waveform having a phase opposite to a phase of a vibration waveform indicating vibration propagated to the right side of steering wheel 10.

In this way, when the right side of steering wheel 10 is vibrated, the vibration propagated to the left side of steering wheel 10 can be suppressed. When the left side of steering wheel 10 is vibrated, the vibration propagated to the right side of steering wheel 10 can be suppressed. Hence, the driver more easily recognizes, by the vibration, whether the notified information is the rightward direction or the leftward direction of vehicle 2.

Information notification device 1 in technique 3 according to the present embodiment is information notification device 1 in technique 2 which further includes: storage 34, and in which storage 34 stores the first waveform and the second waveform beforehand, when controller 33 causes first vibrator 21 to vibrate, controller 33 causes second vibrator 22 to vibrate with the first waveform, and when controller 33 causes second vibrator 22 to vibrate, controller 33 causes first vibrator 21 to vibrate with the second waveform.

In this way, the first waveform and the second waveform are stored beforehand, and thus each time first vibrator 21 is caused to vibrate, the vibration propagated to second vibrator 22 does not need to be detected, and each time second vibrator 22 is caused to vibrate, the vibration propagated to the right side of steering wheel 10 does not need to be detected. In other words, a sensor for detecting the propagated vibration does not need to be additionally provided, and thus it is possible to suppress the complication of information notification device 1 and to suppress an increase in the manufacturing cost of information notification device 1.

Information notification device 1a in technique 4 according to the present embodiment is information notification device 1a in technique 1. In this case, information notification device 1a in technique 4 according to the present embodiment includes: gripping position detector 35 that detects a position of a hand of the driver, the hand gripping steering wheel 10, when controller 33 causes first vibrator 21 to vibrate, controller 33 causes second vibrator 22 to vibrate, according to the position of the hand detected by gripping position detector 35, with a first waveform having a phase opposite to a phase of a vibration waveform indicating vibration propagated to the left side of steering wheel 10, and when controller 33 causes second vibrator 22 to vibrate, controller 33 causes first vibrator 21 to vibrate, according to the position of the hand detected by gripping position detector 35, with a second waveform having a phase opposite to a phase of a vibration waveform indicating vibration propagated to the right side of steering wheel 10.

In this way, when the right side of steering wheel 10 is vibrated, it is possible to more suppress the vibration propagated to the part of steering wheel 10 corresponding to the gripping position of the left hand of the driver. When the left side of steering wheel 10 is vibrated, it is possible to more suppress the vibration propagated to the part of steering wheel 10 corresponding to the gripping position of the right hand of the driver. In other words, in steering wheel 10, one side to which the information is notified can be vibrated, and vibration in a part on the other side corresponding to the gripping position can be suppressed. Hence, the driver more easily recognizes, by the vibration, whether the notified information is the rightward direction or the leftward direction of vehicle 2.

Information notification device 1a in technique 5 according to the present embodiment is information notification device 1a in technique 4 which further includes: storage 34, and in which storage 34 stores the first waveform and the second waveform beforehand, the first waveform corresponding to the position of the hand gripping steering wheel 10, the second waveform corresponding to the position of the hand gripping steering wheel 10, when controller 33 causes first vibrator 21 to vibrate, controller 33 causes second vibrator 22 to vibrate with the first waveform, and when controller 33 causes second vibrator 22 to vibrate, controller 33 causes first vibrator 21 to vibrate with the second waveform.

In this way, the first waveform corresponding to the gripping position of steering wheel 10 and the second waveform corresponding to the gripping position of steering wheel 10 are stored in storage 34 beforehand, and thus each time first vibrator 21 is caused to vibrate, the vibration propagated to second vibrator 22 does not need to be detected, and each time second vibrator 22 is caused to vibrate, the vibration propagated to the right side of steering wheel 10 does not need to be detected. In other words, a sensor for detecting the propagated vibration does not need to be additionally provided, and thus it is possible to suppress the complication of information notification device 1 and to suppress an increase in the manufacturing cost of information notification device 1.

Information notification device 1 or 1a in technique 6 according to the present embodiment is information notification device 1 or 1a in any one of techniques 1 to 5. In this case, when steering wheel 10 is in the neutral position, first vibrator 21 is disposed at right-side spoke 11a or right-side rim 11b located on the right side of steering wheel 10, and second vibrator 22 is disposed at left-side spoke 12a or left-side rim 12b located on the left side of steering wheel 10.

In this way, the driver can dispose first vibrator 21 and second vibrator 22 near the parts gripped by the driver, and thus the driver more easily recognizes, by tactile sense, whether the notified information is the rightward direction or the leftward direction of vehicle 2.

### Other Variations

Although the information notification device according to the present disclosure has been described above based on the above embodiment, the present disclosure is not limited to the embodiment described above. Embodiments obtained by performing various types of variations conceived by those skilled in the art on the embodiment may be included in the present disclosure as long as they do not depart from the spirit of the present disclosure.

For example, the controller and the like included in the information notification device described above are typically realized as an LSI circuit which is an integrated circuit. They may be individually formed into single chips, or a part or all of them may be formed into a single chip.

The method for forming the integrated circuit is not limited to LSI, and the integrated circuit may be realized with a dedicated circuit or a general-purpose processor. A field programmable gate array (FPGA) which can be programed after the manufacturing of an LSI circuit or a configurable processor which allows the connection and setting of circuit cells within an LSI circuit to be reconfigured may be utilized.

In the embodiment described above, the constituent elements may be formed by dedicated hardware, or may be realized by executing software programs suitable for the constituent elements. A program executor such as a CPU or a processor may read and execute software programs recorded in a recording medium such as a hard disk or a semiconductor memory to realize the constituent elements.

All the numbers used in the above description are examples for specifically describing the present disclosure, and the embodiment in the present disclosure is not limited to the numbers described above.

The division of functional blocks in the block diagrams is an example, and a plurality of functional blocks may be realized as one functional block, one functional block may be divided into a plurality of functional blocks, or some functional blocks may be transferred to other functional blocks. The functions of a plurality of functional blocks having similar functions may be processed by hardware or software in parallel or in a time-shared manner.

The order in which the steps in the flowchart are performed is illustrative for specifically describing the present disclosure, and an order other than the order described above may be adopted. Some of the steps may be performed simultaneously (in parallel) with other steps.

Embodiments obtained by performing various types of variations conceived by those skilled in the art on the embodiment described above and embodiments realized by arbitrarily combining the constituent elements and functions in the embodiment without departing from the spirit of the present disclosure are also included in the present disclosure.

### Further Information about Technical Background to this Application

The disclosure of the following patent application including specification, drawings, and claims is incorporated herein by reference in its entirety: Japanese Patent Application No. 2024-218644 filed on December 13, 2024.

### Industrial Applicability

The present disclosure is useful for steering wheels incorporated in moving bodies such as a vehicle, a ship, and an aircraft.

1. An information notification device that notifies information to a driver via a steering wheel, the information notification device comprising:
a first vibrator that is disposed on a right side of the steering wheel when the steering wheel is in a neutral position;
a second vibrator that is disposed on a left side of the steering wheel when the steering wheel is in the neutral position; and
a controller that controls the first vibrator and the second vibrator,
wherein when the controller causes the first vibrator to vibrate, the controller causes the second vibrator to vibrate to suppress vibration on the left side of the steering wheel, and
when the controller causes the second vibrator to vibrate, the controller causes the first vibrator to vibrate to suppress vibration on the right side of the steering wheel.

2. The information notification device according to claim 1,
wherein when the controller causes the first vibrator to vibrate, the controller causes the second vibrator to vibrate with a first waveform having a phase opposite to a phase of a vibration waveform indicating vibration propagated to the left side of the steering wheel, and
when the controller causes the second vibrator to vibrate, the controller causes the first vibrator to vibrate with a second waveform having a phase opposite to a phase of a vibration waveform indicating vibration propagated to the right side of the steering wheel.

3. The information notification device according to claim 2, further comprising:
a storage,
wherein the storage stores the first waveform and the second waveform beforehand,
when the controller causes the first vibrator to vibrate, the controller causes the second vibrator to vibrate with the first waveform, and
when the controller causes the second vibrator to vibrate, the controller causes the first vibrator to vibrate with the second waveform.

4. The information notification device according to claim 1, further comprising:
a gripping position detector that detects a position of a hand of the driver, the hand gripping the steering wheel,
wherein when the controller causes the first vibrator to vibrate, the controller causes the second vibrator to vibrate, according to the position of the hand detected by the gripping position detector, with a first waveform having a phase opposite to a phase of a vibration waveform indicating vibration propagated to the left side of the steering wheel, and
when the controller causes the second vibrator to vibrate, the controller causes the first vibrator to vibrate, according to the position of the hand detected by the gripping position detector, with a second waveform having a phase opposite to a phase of a vibration waveform indicating vibration propagated to the right side of the steering wheel.

5. The information notification device according to claim 4, further comprising:
a storage,
wherein the storage stores the first waveform and the second waveform beforehand, the first waveform corresponding to the position of the hand gripping the steering wheel, the second waveform corresponding to the position of the hand gripping the steering wheel,
when the controller causes the first vibrator to vibrate, the controller causes the second vibrator to vibrate with the first waveform, and
when the controller causes the second vibrator to vibrate, the controller causes the first vibrator to vibrate with the second waveform.

6. The information notification device according to claim 1,
wherein when the steering wheel is in the neutral position, the first vibrator is disposed at a right-side spoke or a right-side rim located on the right side of the steering wheel, and the second vibrator is disposed at a left-side spoke or a left-side rim located on the left side of the steering wheel.
